(19) United States
(12) Patent Application Publication
(10) Pub. No.: US 2022/0069318 A1
(43) Pub. Date: Mar. 3, 2022

(54) Method for Producing Separator Plates for a Fuel Cell

(71) Applicant: fischer Eco Solutions GmbH, Achern-Fautenbach (DE)

(72) Inventors: Morten Sørensen, Gistrup (DK); Søren Juhl Andreasen, Vadum (DK); Denys Gromadskyi, Aalborg Øst (DK); Larysa Hromadska, Aalborg Øst (DK)

(21) Appl. No.: 17/420,150

(22) PCT Filed: Dec. 20, 2019
(86) PCT No.: PCT/EP2019/086722

§ 371 Date: Jul. 1, 2021

(30) Foreign Application Priority Data
Jan. 3, 2019 (DK) PA 2019 70006

(51) Int. Cl. H01M 8/0221; H01M 8/0213; H01M 8/0226; H01M 8/0228

(52) U.S. Cl. CPC H01M 8/0221; H01M 8/0228; H01M 8/0226; H01M 8/0213

(57) ABSTRACT

A method for producing separator plates, in particular bipolar plates, for a fuel cell. The method comprises use of a sacrificial binder.

### FIELD OF THE INVENTION

The present invention relates to a method for producing separator plates, in particular bipolar plates, for a fuel cell.

### BACKGROUND OF THE INVENTION

Proton exchange membrane fuel cells are part of a very promising green technology with wide range of applications, including electric vehicles and stationary electric stations. Especially, high temperature proton exchange membrane (HT-PEM) fuel cells are useful due to their high tolerance for impurities in fuel. However, this kind of fuel cells requires thermo-stable and chemo-stable materials because HT-PEM fuel cells operate at 160-200° C. in strong acidic media. Consequently, utilization of metals like aluminum and stainless steel is undesirable due to their corrosion. In contrast thereto, graphite seems an attractive candidate to substitute metal in the bipolar plates, because it has good resistivity for oxidation and its electrical conductivity can reach 10⁴ S/cm

WO2018/072803 by SerEnergy discloses a method for forming a bipolar plate from a mix of powders of carbon, polyphenylene sulfide (PPS) and polytetrafluoroethylene (PTFE). Although, mixing graphite with PPS allows production of bipolar plates (BPP) applicable for HT-PEM fuel cells by molding technique, handling of fine dispersed powders of graphite and PPS is not easy when large-scale production process takes place. Furthermore, PTFE has a negative influence on conductivity, why PTFE is not an optimum selection.

U.S. Pat. No. 7,736,786 discusses the problem with insufficient conductivity and discloses a manufacturing process for a bipolar plate for a fuel cell, where PPS is mixed with a conductive filler, in particular carbon black, carbon fiber, and/or graphite. In order to obtain a high conductivity, the filler must be well distributed inside the resin, which is difficult in the PPS itself, why a disulfide is added to the resin. For example, 30 parts by weight of PPS, 20 parts by weight of a carbon black as a conductive filler, and 50 parts by weight of graphite were mixed to prepare a basic resin composition. Before adding the filler, two parts of 2,2′-benzothiazolyl disulfide were added to the PPS. The disulfide increases the flowability of the PPS and lowers the viscosity. The disulfide is heat resistant.

Use of sacrificial binders, especially poly(propylene carbonate), for holding two pieces of metal together in high precision manufacturing of products like electronics, fuel cells, nanomaterials and solar panels have been disclosed in the prior art, for example on the internet site https://www.environmentalleader.com/2008/07/novomer-makes-sacrificial-binder-from-recycled-co2/

For example, using sacrificial binders in fuel cell fabrication for various components, not only ceramic parts, is mentioned on the Internet site https://www.azocleantech.com/article.aspx?ArticleID=215.

It reads that poly(alkylene carbonate) copolymer decomposes at very low temperatures, burns out completely and consistently, and offers exceptional green strength for ceramic parts. It mentions benefits for use in the construction of fuel cells. It specifies that this polymer can be used as solid matrix for holding the electrolyte or catalyst in place in the fuel cell.

Use of sacrifical binders in Selective Laser Sintering (SLS) is disclosed in the manuscript “Binder Development for Indirect SLS of Non Metallics” published by Kumaran M. Chakravarthy and David L. Bourell on the Internet: http://sffsymposium.engr.utexas.edu/Manuscripts/2010/2010-39-Chakravarthy.pdf However, this disclosure specifies that sacrificial binders are only useful in the initial stages of the SLS process, why other binders are needed for giving strength during the all stages of the of processing, for example in the production of graphite bipolar plates or current collectors in fuel cells.

Although, sacrificial binders have been associated with fuel cell components, a specific production method for separator plates, for example bipolar plates, has not yet been presented. Thus, there is a need for improvement in the art.

### DESCRIPTION/SUMMARY OF THE INVENTION

It is therefore the object of the invention to provide an improvement in the art. Especially, it is an objective to provide an improved method for production of separator plates, for example bipolar plates (BPP), in fuel cells.

The term “fuel cell” is used herein for individual fuel cells as well as for fuel cell stacks. For example, a fuel cell stack comprises an anode plate and a cathode plate that are combined into a bipolar plate assembly by being attached to each other back-to-back with a sealed cooling-liquid flow-field in between. The invention is useful for individual fuel cells and fuel cell stacks, particular focus is on proton exchange membrane (PEM) fuel cells, especially high-temperature proton exchange membrane (HTPEM) fuel cells.

As explained in the following, the production of separator plates, for example BPP, is based on use of sacrificial binders, i.e. polymers which decompose to gaseous substances that are removed from the composites during the molding process. Examples of such sacrificial binder polymers are copolymers of carbon dioxide and epoxides, for example ethylene oxide propylene oxide or cyclohexene oxide. Alternatively, polysaccharides can be used as sacrificial binder, for example agarose, gluten, or starch or mixtures thereof. In certain embodiments, polycarbonates are more preferred due to their complete decomposition at temperatures in the range of 220-250° C.

In more detail, a powder is provided that contains at least 70%, for example 70-90% or 80-90%, of a carbon material, typically graphite or carbon black or a mixture thereof. Typically, an average grain size is in the range of 0.25 to 5 micrometer. The powder also contains 10-30%, for example 10-20%, of thermoplastic polymer different from PTFE, advantageously PPS.

For example, the powder is a ground powder made from a composite of the carbon material and thermoplastic polymer. Alternatively, the powder is a mix of carbon material, typically graphite powder and/or carbon black, and 10-20% of thermoplastic polymer powder. The combination of carbon material and thermoplastic polymer contains 80 to 90 wt. % carbon material and 10 to 20 wt. % thermoplastic polymer, the latter adding to the carbon material to reach 100% . The percentage is by weight and is calculated relative to the weight of the mix of carbon material and thermoplastic polymer.

Furthermore, a liquid solution of a sacrificial binder is provided. For example, the sacrificial binder is a polycarbonate polymer. Good candidates are copolymers of carbon dioxide and epoxide, for example polyethylene carbonate, polypropylene carbonate, or polycyclohexene carbonate. The polycarbonate polymer is dissolved in an organic solvent, thus providing a liquid phase solution of the sacrificial binder. For example, the solvent comprises at least 50% of its weight as acetone. In experiments, the polycarbonate polymer was dissolved in acetone as a solvent.

As an alternative to the polycarbonate polymer, the sacrificial binder may be a polysaccharide or a mix of polysaccharides. In this case, the solvent is aqueous, for example water, in which the polysaccharide is dissolved. Useful polysaccharides are agarose, gluten, or starch, optionally a mixture of at least two of these polysaccharides. Advantageously, a non-ionic surfactant is added to the aqueous solution, for example octyl phenol ethoxylate or dioctyl sodium sulfosuccinate.

The liquid solution that contains the binder is mixed with the powder. Subsequently the sacrificial binder is sedimented from the solution together with the powder as a slurry. Optionally, in order to promote sedimentation, a coagulation agent is added to the solution at a concentration that causes the sedimentation of the sacrificial binder from the solution. A useful coagulation agent is iso-propanol.

The sedimented slurry is then dried to form a mat of the powder and sacrificial binder. For example, in order to evaporate the solvent, the temperature of the solution is raised while being kept below the boiling point of the solvent. Optionally, in order to ease drying, excess liquid is removed from the slurry prior to or during heating. If acetone is used as a solvent, the temperature should not exceed 56° C. If the solvent is water and iso-propanol, the temperature should not exceed 80° C. in order to prevent boiling.

By using a press-mold, this dried mat of carbon material and sacrificial binder is then hot-press molded into the shape of a separator plate at a molding temperature that causes evaporation of at least part of the sacrificial binder. The shape optionally contains the channels that are necessary for the flow of the reactants and or the cooling of the fuel cell.

A typical pressure is in the range of 10 to 100 MP. However, also higher pressures up to 400 MP are possible.

A typical temperature is in the range of 280 to 480° C., however, the temperature depends on the sacrificial binder. For example, the hot-press temperature is at least 25% higher than the decomposition temperature of the sacrificial binder.

Some examples of decomposition temperatures are 220° C. for polyethylene carbonate and 250° C. for polypropylene carbonate and polycyclohexene carbonate, 250° C. for gluten, 280° C. for agarose, and 300° C. for starch. Whereas, the polycarbonate polymer can be completely decomposed at elevated temperatures above 220° C., only 25-30% of the polysaccharide is decomposed at a temperature above 250° C. In some embodiments, at least 80% of polycarbonate polymer is decomposed or, alternatively, at least the 20% of the polysaccharide is decomposed.

The method is useful as a scalable production method where the separator plates are free from PTFE.

### SHORT DESCRIPTION OF THE DRAWINGS

The invention will be explained in more detail with reference to the drawing, where

FIG. 1 is a perspective exploded view of a fuel sell stack assembly according to the present invention showing bipolar plates, membranes, sealants and endplates;

FIG. 2 is a perspective view of the cathode side of one “sandwich element” comprising (from left to right): a sealant for sealing off the cathode side of a PEM bipolar plate; a PEM bipolar plate; a sealant for sealing off the anode side of a PEM bipolar plate; and finally a membrane;

FIG. 3 is a perspective view of the anode side of one “sandwich element” comprising (from left to right): a membrane; a sealant for sealing off the anode side of a PEM bipolar plate; a PEM bipolar plate; and finally a sealant for sealing off the cathode side of a PEM bipolar plate;

FIG. 4 illustrates a fuel cell stack principle, where a bipolar plate is used between electrolytic membranes;

FIG. 5 illustrates alternative fuel cell stack principles, where an anode plate and a cathode plate are oriented back-to-back with a cooling section between the anode plate and the cathode plate;

FIG. 6 illustrates a further alternative fuel cell stack principle, where a cooling plate is sandwiched between a cathode plate and an anode plate and cooling is provided in the volume between the cooling plate and the anode plate and in the volume between the cooling plate and the cathode plate;

FIG. 7 illustrates stages of the production method of a separator plate.

### DETAILED DESCRIPTION/PREFERRED EMBODIMENT

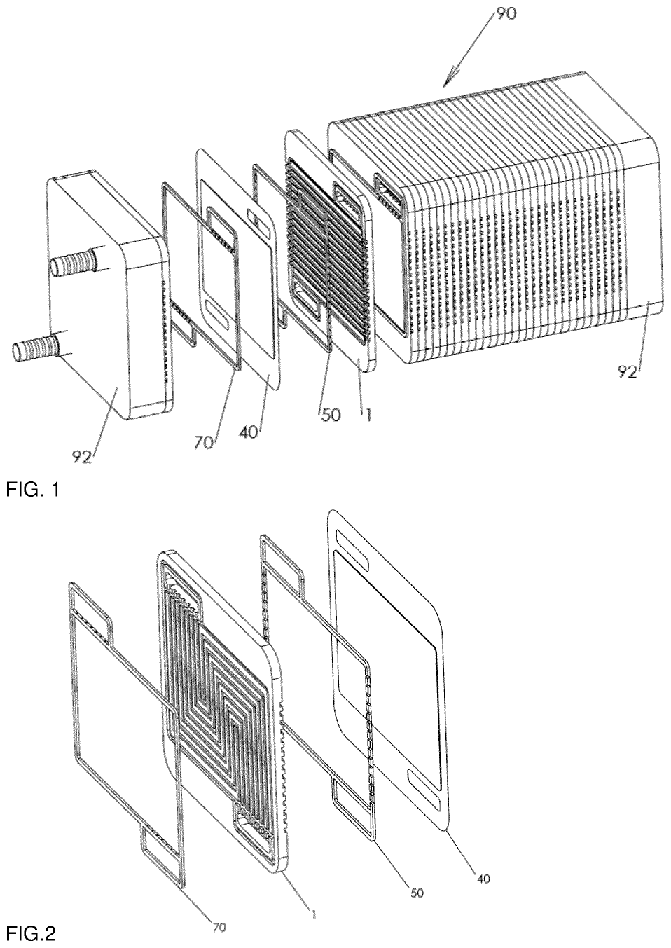

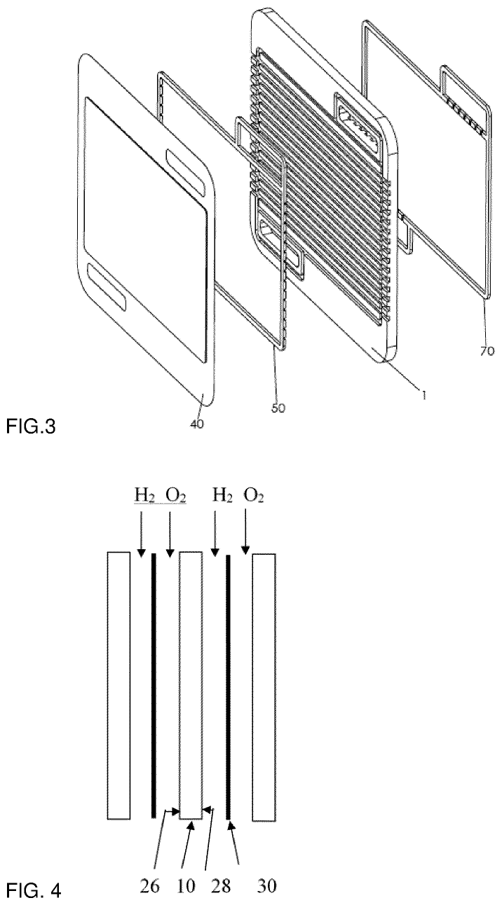

FIG. 1 illustrates a PEM fuel cell stack 90 comprising a plurality of bipolar plates 1 assembled between endplates 92. Proton exchange membranes (PEM) 40 between adjacent bipolar plates 1 are sealed against the environment by sealants 70 and 50. FIG. 2 is a perspective view onto the cathode side of the bipolar plate 1 assembly comprising the membrane 40 and a sealant 70 for sealing off the cathode side of a PEM bipolar plate and a sealant 50 for sealing off the anode side of a PEM bipolar plate. Correspondingly, FIG. 3 is a perspective view onto the anode side of the bipolar plate 1 assembly. The cathode side comprises a serpentine channel pattern for flow of oxygen gas along the membrane 40 and efficient cooling by the oxygen gas, typically air. The anode side comprises straight channels for transport of hydrogen along the membrane 40.

FIG. 4 illustrates such configuration with a bipolar plate 10, on the anode side 28 of which a hydrogen flow is provided for donating protons to the electrolytic membrane 30 and with a cathode side 26 on which oxygen or air or other fluid flows for accepting protons from the membrane 30. The cathode fluid, for example oxygen or air is used as a cooling medium for cooling the bipolar plate. The cathode side 26 of the bipolar plate 1 is provided with a serpentine channel pattern as described above. Exemplary details of the channel patterns and other details of the bipolar plate are explained in WO2009/010066 and WO2009/010067.

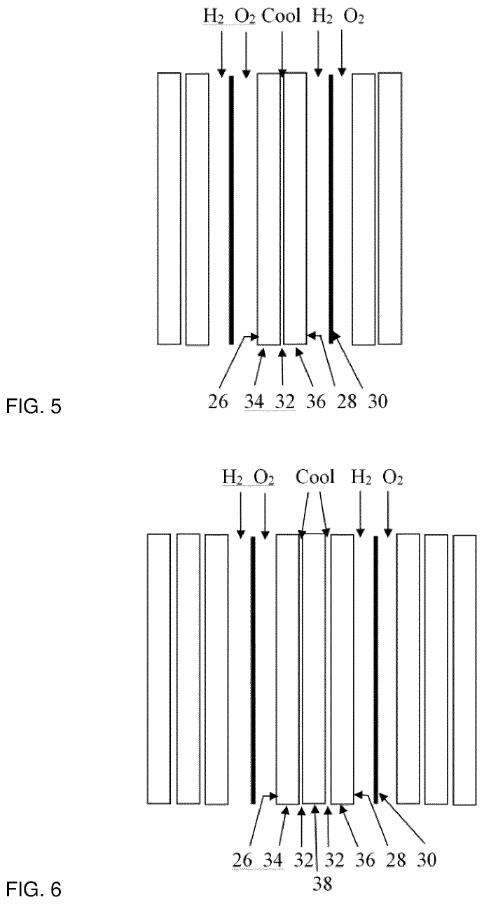

The production method for separator plates as described herein is not only suitable for bipolar plates. It applies equally well to other separator plates, such as cathode plates, anode plates and cooling plates. Such examples are illustrated in FIGS. 5 and 6.

FIG. 5 illustrates an embodiment, where a cathode plate 34 with a cathode side 26 is combined with an anode plate 36 with anode side 28 and with cooling fluid 32, for example gas or liquid in a space 32 between the two plates. In the space 32, the cathode plate 34 or the anode plate 36 are provided with a channel pattern for example serpentine channel pattern, as described above for efficient cooling by the cooling fluid.

FIG. 6 illustrates a further alternative, where a cathode plate 34 and an anode plate 36 are sandwiching a cooling plate 38 such that two cooling spaces 32 are provided, one cooling volume between the cooling plate 38 and the cathode plate 34 and another cooling volume between the cooling plate 38 and the anode plate 36. The cooling plate 38 is provided with a channel pattern on both of its sides, for example a serpentine channel pattern as described above.

The production of the separator plates, for example BPP, is based on use of sacrificial binders, such as polymers which decompose to gaseous substances for removal from the composites during the molding process.

Data of temperatures T_{d} when rapid decomposition starts and residual contents Cᵣ for the mentioned polymers at 360° C. are collected in Table 1 below. It should be mentioned that 360° C. is a useful reference point because the highest crystallinity index is achieved for molded PPS at that temperature.

TABLE 1
Decomposition temperatures of some polymers
determined via thermogravimetric analysis

| Sacrificial polymer name | T_{d} (° C.) | C_{R} (%) |
|---|---|---|
| polyethylene carbonate | ca. 220 | ca. 0 |
| polypropylene carbonate | ca. 250 | ca. 0 |
| polycyclohexene carbonate | ca. 250 | ca. 0 |
| agarose | ca. 280 | ca. 25 |
| gluten | ca. 240 | ca. 30 |
| starch | ca. 300 | ca. 25 |

With reference to the Table 1 given above, polycarbonates are more preferred due to their complete decomposition at specified temperature. However, despite incomplete decomposition, polysaccharides are interesting for this purpose, as well.

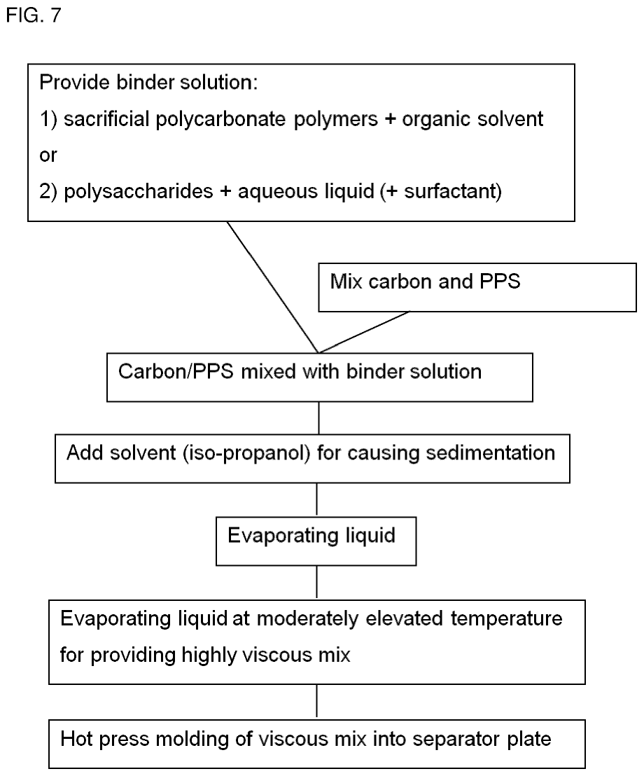

In more detail, the following production method has been found useful, in which separator plates (anode plates, cathode plates, or bipolar plates) were manufactured as follows, with reference to FIG. 7 as an exemplary embodiment thereof.

A powder is provided which contains at least 70%, for example 70-90% or 80-90%, graphite and/or carbon black, as well as 10-20% of thermoplastic polymer. For example, the powder is a ground powder made from a composite of these ingredients. Alternatively, the powder is a mix of graphite powder and/or carbon black with an average grain size in the range of 0.25 to 5 microns and 10-20% of thermoplastic polymer powder. The combination of carbon and thermoplastic polymer containing 80 to 90 wt. % carbon material and 10 to 20 wt. % thermoplastic polymer, the latter adding up to 100% relative to the carbon. The percentage by weight and calculated relatively to the weight of the mix of carbon and thermoplastic polymer.

A useful example of a thermoplastic polymer is PPS, which is advantageous due to its high chemical stability. In the following, the method is exemplified with PPS, although also other thermoplastic polymers or blends of thermoplastic polymers can be used. If another thermoplastic polymer is used, the PPS in the method below is substituted by the other thermoplastic polymer or blend of thermoplastic polymers. This mix of carbon and thermoplastic polymer mix was added to a liquid binder solution.

One option for a liquid binder material solution is a solution that contains sacrificial polycarbonate polymers. In this case, the polymer was dissolved in organic solvents, for example acetone-based, such as acetone. Optionally, the concentrations of the polymer is ranges from 0.5 to 30 wt. % of the solution.

Another option for binder material are polysaccharides. In this case, the solvent is aqueous, for example water. Optionally, the concentrations of the polysaccharides is ranges from 0.5 to 30 wt. % of the aqueous solution. Optionally, in order to improve wettability of the carbon-based composites, a non-ionic surfactant is added, for example at a concentration of 1-2 vol. %. A useful example of a non-ionic surfactant is octyl phenol ethoxylate, for example commercially available under the trade name Triton™ X-100 from Dow Chemical Company®.

For example, the solutions are prepared by equal weight amounts of carbon/PPS composite and binder solution. The combination of the composite and binder solution is advantageously made while stirring.

For example, the amount of sacrificial polymer solid in the final composition is in the range of 1 to 10 wt. %.

Advantageously, further solvent is added to the combined mix of composite and binder solution, where the solvent is of the type that easy mixes with the solvent and provokes sedimentation of the sacrificial binder from the solution. A useful example in the aqueous case is water or iso-propanol, which is also a useful example for the acetone based binder solution. Other useful organic solvents include polar solvents that have low surface tension and good wetting capabilities for the components. A useful candidate is metoxybenzen.

The sedimentation is typically achieved during stirring.

The sedimentation of the binder from the solution leads to a highly viscous material, which is used for the hot-pressing step in the pressing tool. However, before hot-pressing, the liquid from the binder, for example containing a mixture of iso-propanol with water or acetone, is subjected to evaporation at temperatures that do not exceed their boiling points. For example, the evaporation stage is done at a temperature in the range of 70-80° C., optionally at 80° C., for a water/iso-propanol azeotropic mixture and at a temperature in the range of 50-56° C., optionally at 56° C., for acetone/iso-propanol, the latter temperature being determined by the boiling point of acetone.

Due to the evaporation, the viscous material dries into mechanically stable mats. Typically, the drying time is at least 1 h. Optionally, this drying step is made while the mix is already in the pressing tool.

As a second heating step, the pressing tool is used for hot-pressing the mats located in the pressing tool at temperatures in the range between 280 and 480° C., depending on the type of sacrificial binder. This range is limited by the melting point and decomposition temperature of the PPS, which is not desired to decompose.

During the hot-pressing, pressure is applied, typically in the range 10 to 100 MPa, to form a separator plate, for example bipolar plate, with specified desired parameters, such as thickness and density.

Key characteristics for separator plates for the fuel cell's stack are their electrical conductivity, especially through-plane conductivity. Experimentally, measurements were carried out in this respect. According to these measurements, through-plane conductivity for BPPs with 2 wt. % sacrificial binder produced by the above-described method reached 30 S/cm. In comparison, similar BPPs with 2 wt. % PTFE had about 20 S/cm. The latter were produced by the method as disclosed in WO2018/072803.

In summary, a number of advantages were achieved as compared to the method as disclosed in WO2018/072803:
better electrical properties due to thermal decomposition of binders forming the carbon-based mats during molding process;
less toxic molding process due to use of biodegradable polymers instead of PTFE, which can be the source of toxic fluorine-contained substances at elevated temperatures;
no need to apply heat to coagulate (sediment) the binder as it is performed in WO2018/072803;
the mat forming process moves faster, because coagulation is rapid.

As it appears from the above, a useful scalable production method has been found in use of a sacrificial binder and the two-step heating process for first evaporating the solvent and then the binder. Also, a useful part of the method is the precipitation process.

1. A method of producing a separator plate for a fuel cell by providing a powder containing at least 70% graphite or carbon black or both and 10-30% thermoplastic polymer different from PTFE, all percentages by weight of the powder, the method comprises providing a liquid solution of a sacrificial binder and mixing the liquid solution with the powder and sedimenting the sacrificial binder and the powder as a slurry from the liquid solution, drying the slurry to form a mat of powder and sacrificial binder, and hot-press moulding the mat in a press mold into a shape of a separator plate at a molding temperature that causes evaporation of at least part of the sacrificial binder, wherein the sacrificial binder is chosen from a polycarbonate polymer, a polysaccharide or a mix of polysaccharides.

2. A method according to claim 1, wherein the thermoplastic polymer is polyphenylene sulfide, PPS.

3. A method according to claim 1, wherein the method comprises adding coagulation agent to the solution at a concentration that causes the sedimentation of the sacrificial binder from the solution.

4. A method according to claim 3, wherein the coagulation agent is iso-propanol.

5. A method according to claim 1, wherein the method comprises, prior to the hot-press moulding, drying the slurry into a mat by heating the solution with the mixed powder to a temperature that does not exceed the boiling point of the solvent and causing evaporation of the solvent.

6. A method according to claim 1, wherein the method comprises hot-press molding the mat into a separator plate at a pressure in the range of 10 to 100 MPa and a temperature that is at least 25% higher than the decomposition temperature of the sacrificial binder and in the range of 280 to 480° C.

7. A method according to claim 1, wherein the sacrificial binder is polycarbonate polymer, and the method comprises dissolving the sacrificial binder in an organic solvent for providing the liquid solution of the sacrificial binder.

8. A method according to claim 7, wherein the sacrificial binder is a copolymer of carbon dioxide and epoxide.

9. A method according to claim 8, wherein the sacrificial binder is at least one of polyethylene carbonate, polypropylene carbonate, or polycyclohexene carbonate, and the method comprises decomposing at least 80% of the sacrificial binder.

10. A method according to claim 7, wherein the solvent comprises at least 50% of its weight as acetone.

11. A method according to claim 1, wherein the sacrificial binder is a polysaccharide or a mix of polysaccharides, and the solvent is aqueous, and the method comprises dissolving the polysaccharide in the aqueous solvent for providing the liquid solution of the sacrificial binder.

12. A method according to claim 11, wherein the polysaccharide is at least one of agarose, gluten or starch, and the method comprises decomposing at least 20% of the sacrificial binder.

13. A method according to claim 12, wherein the method comprises adding a non-ionic surfactant to the aqueous solution.

14. A method according to claim 13, wherein the method comprises adding octyl phenol ethoxylate as the non-ionic surfactant.
